(19) United States
(12) Patent Application Publication
(10) Pub. No.: US 2007/0181079 A1
(43) Pub. Date: Aug. 9, 2007

(54) Portable anchoring tether device and method of use

(75) Inventor: Chia-Pao Fong, Nanjing (TW)

Correspondence Address: Akin Gump Strauss Hauer & Feld LLP, P O Box 688, Dallas, TX, 75313-0688, US

(73) Assignee: Nanjing Yau Feng Hardware Co., Ltd., Nanjing (CN)

(21) Appl. No.: 11/388,183

(22) Filed: Mar. 23, 2006

(30) Foreign Application Priority Data
Feb. 9, 2006 (CN) 200620069193.7

(51) Int. Cl. A01K 3/00

(52) U.S. Cl. 119/786

(57) ABSTRACT

A tether device is disclosed. The tether device includes tether member and an anchor shaft, wherein the tether member includes a lead, a housing member, a clamp, and a central cavity.

### STATEMENT REGARDING FEDERALLY SPONSORED RESEARCH OR DEVELOPMENT

Not Applicable.

### REFERENCE TO A “MICROFICHE APPENDIX”

Not Applicable.

### BACKGROUND OF THE INVENTION

The present invention generally relates to pet accessories or supplies. Specifically, the present invention relates to a device for the temporary tether and/or restraining of dogs or other animals.

Animal tether or restraining devices are widely used. One of the most widely used such devices is a leash which can be attached to a collar or harness on the animal. Recently, more practical devices have been developed, which include retractable tether devices. These devices typically include a collar or similar elements for attaching an animal, a lead, and a handle which includes a base containing a mechanism for compactly housing and retracting the lead, such as a spring-loaded reeling device.

A retractable tether device has a number of advantages such as avoiding a tethered animal being tangled with the lead and better control over the animal with constant tension. However, oftentimes it is desired to keep an animal tethered to a fixed point with a restraint. For example, in a yard without fence; or in an open field when a person needs to perform other tasks without the animal roaming over other places.

There is a need for an improved tether device allowing a retractable tether device to be easily tethered, easily operable, flexible, and avoiding tangling with a tethered animal.

### SUMMARY OF THE INVENTION

The present invention discloses a tether device for temporarily securing a restraint to a fixed point. The device includes a retractable tether member connected to a leash, which is used for attaching to a collar or harness on an animal; the retractable tether member having a cylindrical cavity in the central area of the retractable tether member, rotatably attached to the upper portion of a shaft, and the lower portion of the shaft is used for insertion into the ground to assist with stabilization of the shaft.

One object of the present invention is to provide a retractable tether device that can be stabilized at a fixed point without tangling the tethered animal.

Another object of the present invention is to provide a retractable tether device having an anchor shaft that allows quick insertion and removal for temporary use in any grass, dirt, or hard parked sand area, without the need of tools.

Yet another object of the present invention is to provide a retractable tether device that can be easily assembled and disassembled without the need of tools.

Therefore, in accordance with the previous summary, objects, features and advantages of the present disclosure will become apparent to a person of the ordinary skill in the art from the subsequent description and the appended claims taken in juncture with the accompanying drawings.

### BRIEF DESCRIPTION OF THE DRAWINGS

FIG. 1 shows a perspective view for the use of a tether device according to the present invention;

FIG. 2A is a side view of a tether device according to the present invention;

FIG. 2B is a top view of a tether device according to the present invention;

FIG. 3 shows the structure of the anchor shaft for the tether device according to the present invention; and

FIGS. 4A and 4B together show the structure of a tether portion of the tether device detached from the anchor shaft of the tether device according to the present invention.

### DETAILED DESCRIPTION

The present invention provides a unique device and method for tethering an animal at a temporary fixed point. It is understood, however, that the following disclosure provides many different embodiments, or examples, for implementing different features of the invention. Specific examples of components, protocols, and arrangements are described below to simplify the present disclosure. These are, of course, merely examples and are not intended to limit the invention from that described in the claims. Well known elements are presented without detailed description in order not to obscure the present invention in unnecessary detail. For the most part, details unnecessary to obtain a complete understanding of the present invention have been omitted inasmuch as such details are within the skills of persons of ordinary skill in the relevant art.

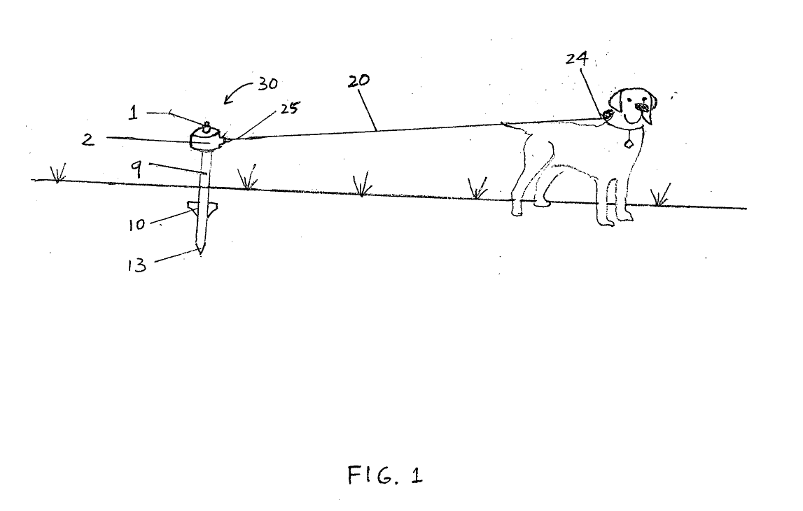

Now referring to FIG. 1, a perspective view for the use of a tether device 30 with an anchor shaft 9 according to the present invention is illustrated. As shown in FIG. 1, a dog is leashed with a first end 24 of a lead 20 of a leash attached to a collar of the dog, and a second end 25 extended from a lead housing 2 of a tether device 30. The lead housing 2, having a central cavity 21 extending from a central position of the lead housing 2 (shown in FIGS, 4A and 4B), is fitted to the upper portion of an anchor shaft 9 of the tether device 30 and secured by fastening a fasten knob 1 onto the top of the anchor shaft 9. A sharp end 13 of the anchor shaft 9 is inserted into the ground for stabilizing the anchor shaft 9 and the lead housing 2. A stabilization plate 10 further assists to stabilize the anchor shaft 9 in the ground. The lead housing 2 freely rotates on a horizontal plane around a centralized longitudinal axis of the anchor shaft 9 when the dog moves within the area, whereby allowing the full length of the lead 20 to serve as a radius.

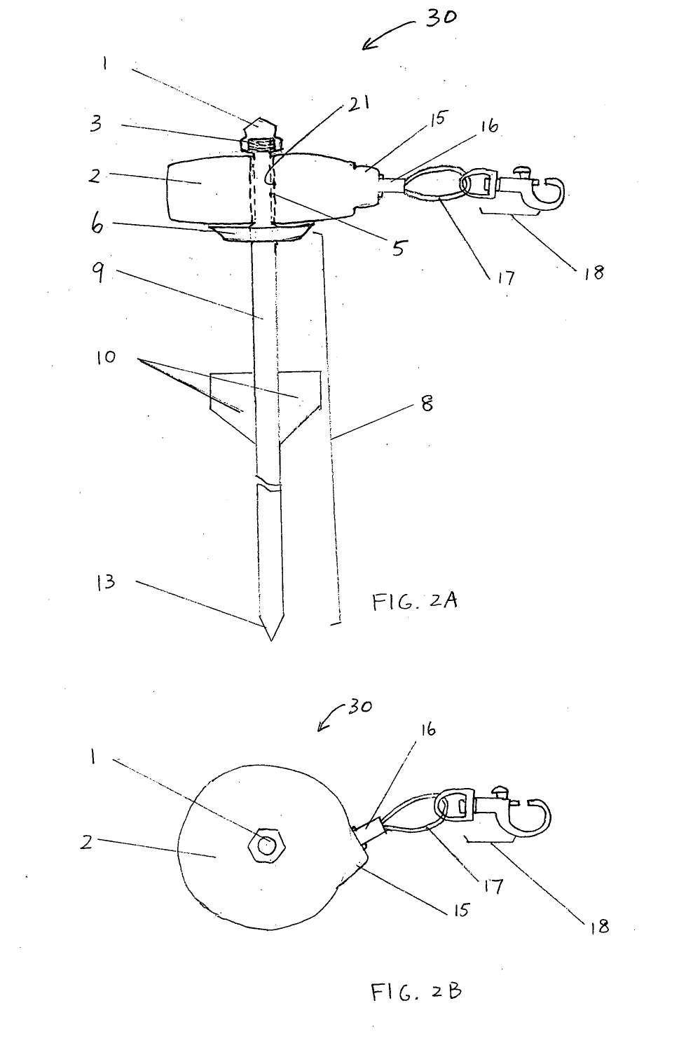

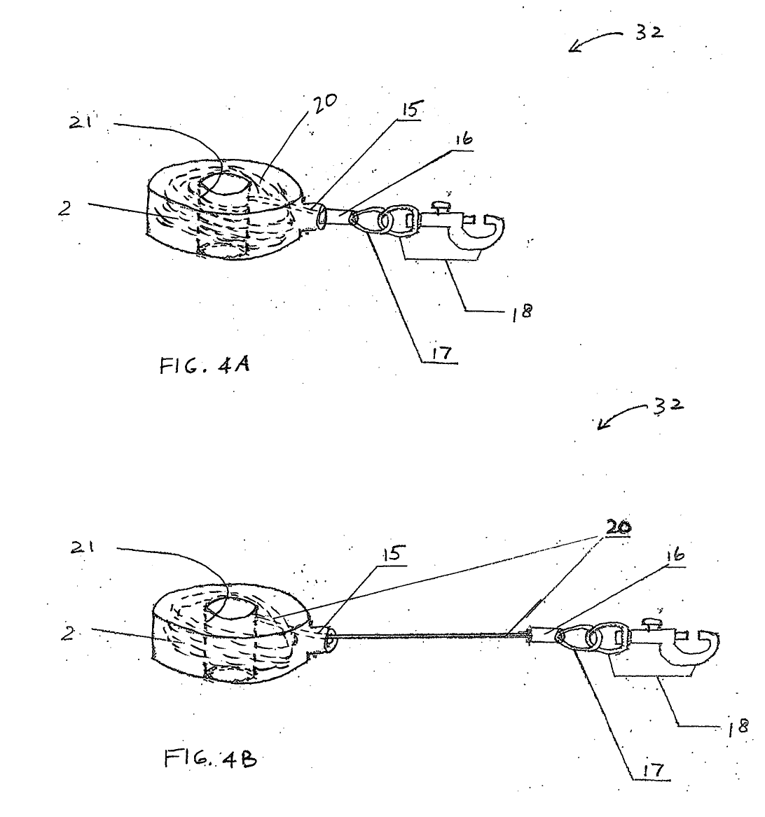

Now turning to FIGS. 2A and 2B. FIG. 2A is a side view of the tether device 30 according to the present invention. The tether portion of the tether device 30 includes the lead housing 2 where a lead 20 (shown in FIG. 1 and FIG. 4B) is housed when retracted, a lead open tube 15 where the lead retracts into and extracts out of the lead housing 2. The tether device 30 further includes a lead clamp 16 wherein one end of the lead 20 forms a circular lead end 17, and a lead connector 18 connecting the circular lead end 17 and a collar or harness of an animal. A person of the ordinary skill in the art will understand that a similar retractable tether devices can be used to fulfill the purposes of the present invention.

As shown in FIG. 2A, the anchor shaft 9 of the tether device 30 is, but not limited to, a cylindrical shaft, rod or stake as the main body. A person in the ordinary skill in the art will understand, the main body of the anchor shaft 9 can be other shapes. The anchor shaft 9 includes the fasten knob 1, a fitting portion 5 of the anchor shaft 9, and a lower portion 8. The fitting portion 5 includes a threaded male screw top 3 for matching a threaded female screw cavity (not specifically shown in FIGS) inside of the fasten knob 1. The lower portion 8 of the anchor shaft 9 includes a stabilization plate 10 and the sharp end 13. As shown in FIG. 2A, the diameter of the fitting portion 5 is smaller than the diameter of the lower portion 8 of the anchor shaft 9. A support plate 6 is fitted at the juncture of the fitting portion 5 and the lower portion 8. The support plate 6 functions to support the lead housing 2. Specifically, the lead housing 2 is situated on the support plate 6 while fitted perpendicularly to the fitting portion 5 of the anchor shaft 9 through the central cavity 21 on the central area of the lead housing 2. The diameter of the central cavity 21 of the tether housing 2 is slightly larger than the diameter of the fitting portion 5 of the anchor shaft 9 so that the lead housing 2 can be fitted along the fitting portion 5 of the anchor shaft 9 thereby allowing the lead housing 2 can be freely rotates on a horizontal plane around a centralized longitudinal axis of the anchor shaft 9.

According to one. embodiment of the present invention as shown in FIG. 2A, when the fasten knob 1 is fully screwed on the threaded male screw top 3, the fasten knob 1 does not directly engage the top of the lead housing 2 in such a way to immobilize the lead housing 2 as shown in FIG. 2A. Specifically, the lead housing 2 can freely rotate without being restricted due to engagement of the fasten knob 1 with the top of the lead housing 2.

According to another embodiment of the present invention, the support plate 6 does not directly engage the bottom of the lead housing 2. In yet another embodiment, the support plate 6 is a cup-shaped structure where the edge of the support plate 6 attaches and supports the lead housing 2. The fasten knob 1 and the support plate 6 are so designed that the fasten knob 1 and the support plate 6 confine the lead housing 2 fitting on the fitting portion 5 of the anchor shaft 9 on the perpendicular plane, yet do not hinder the free rotating motion of the lead housing 2 on the horizontal plane.

FIG. 2B is a top view of the tether device 30 according to the present invention. As shown in FIG. 2B, together with FIG. 2A, the fasten knob 1 is screwed on the top of the lead housing 2. The lead open tube 15 is an extension of the circular structure of the lead housing 2. A lead clamp 16 forms a circular lead end 17, and a lead connector 18 is connected to the circular lead end 17. In one embodiment of the present invention, the diameter of the lead clamp is slightly larger than the diameter of the opening of the lead open tube 15, thereby ensuring that the lead clamp 16 will not stick into the lead open tube 15 when the lead is fully retracted.

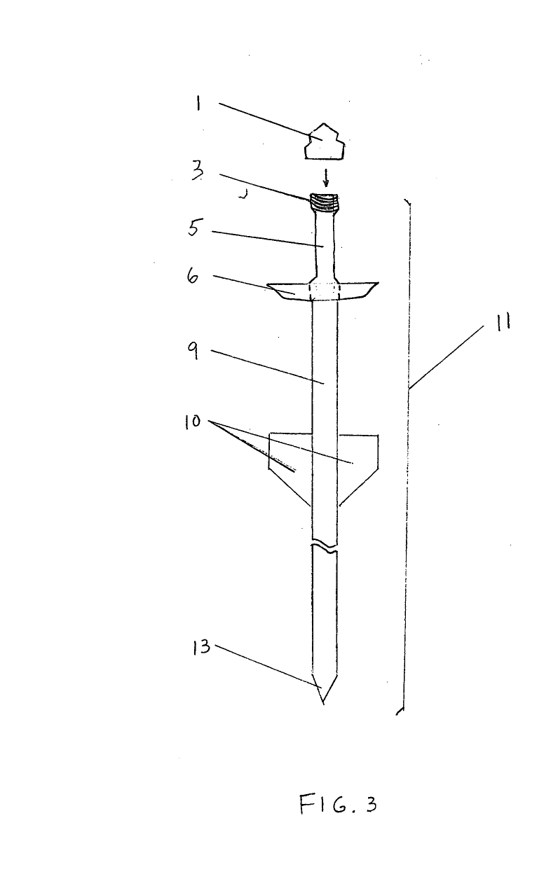

Now referring to FIG. 3, the structure of the anchor shaft 9 for the tether device according to the present invention is illustrated. As shown in FIG. 3, the anchor shaft 9 include the fasten knob 1 and a shaft portion 11. The shaft portion 11 includes the threaded male screw top 3 for matching the threaded female screw cavity within the fasten knob 1. The fitting portion 5 provides a fitting slot for the lead housing 2 as shown in FIG. 2A, the support plate 6 sitting in juncture with the fitting portion 5 and the lower portion of the anchor shaft 9, the stabilization plate 10 integrally connects the lower portion of the anchor shaft 9 and the sharp end 13 of the anchor shaft 9. The position and the structure of the stabilization plate 10 are so designed that the anchor shaft 9 can be easily inserted into and removed from the ground thereby stabilizing the anchor shaft 9 when the stabilization plate 10 is adequately inserted into the ground.

A person of the ordinary skill in the art will understand, that shape, length, and diameter of the anchor shaft 9 can be so designed that the anchor shaft 9 can be easily assembled and disassembled with a desired tether portion, easily inserted into and removed from the ground, and easily carried around by a person.

FIGS. 4A and 4B together show the structure of a tether portion 32 of the tether device 30 (shown in FIGS. 2A and 2B) detached from the anchor shaft 9 according to the present invention. The tether portion 32 includes the lead housing 2, the lead open tube 15, the lead clamp 16, the circular lead end 17, and the lead connector 18. The lead housing 2 is an integral donut shape including the central cavity 21. The central cavity 21 is a cylindrical shape extending through the central area of the lead housing 2. The diameter of the central cavity 21 is larger than the diameter of the threaded male screw top 3 and the diameter of the fitting portion 5, yet smaller than the diameter of the lower portion 8 of the anchor shaft 9, as shown in FIGS. 2A, 2B, and 3.

The central cavity 21 is so designed that allows the lead housing 2 fit onto the fitting portion 5 of the anchor shaft 9 and yet freely rotate on a horizontal plane around a centralized longitudinal axis of the anchor shaft 9. The wall of the central cavity 21 is integrally connected to the top and the bottom of the lead housing 2. The lead housing 2 is designed to house a spring-loaded reel mechanism (not shown) within the lead housing 2 wherein the lead 20 is housed around the inner wall of the central cavity 21 within the lead housing 2.

Shown in FIG. 4A, the lead 20 is fully retracted and the majority portion of the lead 20 is compacted around the inner wall of the central cavity 21 within the lead housing 2. Also shown in FIG. 4B, the lead 20 is partially retracted while a portion of the lead 20 is stretched out and another portion of the lead 20 is compacted around the inner wall of the central cavity 21 within the lead housing 2.

A person of the ordinary skill in the art will understand, the materials for making the tether device 30 including the tether portion 32, the anchor shaft 9 and the components therein can be, but are not limited to, metals, resilient plastics, alloys, and other materials that can sustain ordinary wear and tear.

The previous description of the disclosed embodiments is provided to enable those skilled in the art to make or use the present invention. Various modifications to these embodiments will be readily apparent to those skilled in the art and generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A tether device comprising:
a tether member comprising:
a lead;
a housing member for retaining the lead when retracted;
a clamp wherein by selectively engaging the clamp to allow the lead to lock at one point when extending from or retracting into the tether member, or by selectively disengaging the clamp to allow the lead to extend from or retract into the tether member; and
a central cavity; and
an anchor shaft comprising a first portion and a second portion; wherein
the first portion of the anchor shaft passes through the central cavity of the tether member thereby allowing the tether member to rotate freely along a centralized perpendicular axis to the anchor shaft; and
the second portion of the anchor shaft having at least a stabilization shaft, is inserted into the ground thereby stabilizing the tether device.

2. (canceled)

3. The tether device in claim 1, wherein the tether member is a spring-loaded reel device.

4. The tether device in claim 1, wherein the central cavity is a cylindrical cavity penetrating through the tether member.

5. (canceled)

6. The tether device in claim 1, wherein the anchor shaft further comprises a sharp end.

7. (canceled)

8. The tether device in claim 1, wherein the anchor shaft further comprises a threaded male screw top on the end of the first portion of the anchor shaft and a fasten knob wherein the fasten knob is screwed on the threaded male screw top, thereby securing the retractable tether member.

9. The tether device in claim 8, wherein the fasten knob does not engage the top portion of the retractable tether member when the fasten knob is fully screwed on the threaded male screw top of the anchor shaft, thereby allowing the tether member to rotate freely and perpendicularly to the anchor shaft.

10. The tether device in claim 1, wherein the anchor shaft further comprises a support plate situated at the juncture of the first portion and the second portion of the anchor shaft and perpendicularly to the anchor shaft.

11. The tether device in claim 10, wherein the support plate is removable.

12. The tether device in claim 10, wherein the support plate is a cup structure wherein the edge of the cup structure engages a bottom portion of the tether member.

13. A method of tethering an animal, the method comprising:
providing a retractable tether member wherein the retractable tether member comprises a central cavity,
providing an anchor shaft wherein the anchor shaft comprises a first portion and a second portion,
passing the first portion of the anchor shaft through the central cavity of the retractable tether member; and
allowing the retractable tether member to rotate freely along a centralized perpendicular axis to the anchor shaft.

14. The method of tethering an animal in claim 13, further comprising,
inserting the second portion of the anchor shaft into ground.
